(19) United States
(12) Patent Application Publication
(10) Pub. No.: US 2006/0128907 A1
(43) Pub. Date: Jun. 15, 2006

(54) Process for making a thermoplastic vulcanizates

(76) Inventor: Thomas Chen-chi Yu, Santa Monica, CA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/537,892

(22) PCT Filed: Jun. 12, 2003
(86) PCT No.: PCT/US03/18713

§ 371 Date: Jun. 7, 2005

(30) Foreign Application Priority Data
Dec. 12, 2002 (WO) PCT/US02/39797

(51) Int. Cl. C08L 83/00; C08L 83/04

(52) U.S. Cl. 525/474

(57) ABSTRACT

A process for making a thermoplastic vulcanizate (TPV) in a reactor is provided wherein a mixture is formed in which a silane grafted resilient polymer component is dispersed in a thermoplastic matrix component. The mixture is formed by mixing in a reactor a) from 25 to 60 parts by weight of a resilient polymer component per 100 parts by weight of the matrix component and resilient polymer component combined, b) from 40 to 75 parts by weight of a matrix component, per 100 parts by weight of the matrix component and resilient polymer component combined; and c) a silane grafting agent. The silane grafted resilient polymer component is crosslinked by adding a solid water-generating agent to the reactor.

### 1. FIELD OF THE INVENTION

This invention relates generally to a process for making thermoplastic vulcanizates to be used, for example, in automotive applications and as PVC replacements.

### 2. BACKGROUND

A thermoplastic vulcanizate (“TPV”) is generally known to be a reprocessable material that has at least one partially or fully crosslinked rubber or elastomer component dispersed in a thermoplastic matrix component. Generally, TPVs are prepared by blending the materials for the matrix and elastomer components along with desired additives and a sulfur or peroxide cure package to promote at least partial crosslinking of the elastomer component. The blending is performed in a large scale mixer and the grafting is performed with the aid of unsaturated functionality in the polymer chains of the elastomer, provided by units derived from dienes such as ethylidene norbornene.

The mixers are continuous and the TPV is provided in the form of pellets. Upon reaching temperatures above the softening point or melting point of the matrix component, a TPV can form continuous sheets and/or molded articles with complete knitting or fusion of the TPV under conventional molding or shaping conditions for thermoplastics. A TPV possesses the properties of a thermoset elastomer and is re-processable in an internal mixer.

In practical use, known procedures for making and converting TPV's into a shaped article have limitations. For example, it is difficult to convert polymers not having units derived from dienes. The overall process has many steps with the TPV supplied by a TPV manufacturer from a limited grade-slate, restricting adaptations of the formulation to specific end use requirements.

It is known to graft polyolefins with silanes in, for example, electrical applications, and to allow moisture to effect cross-linking subsequent to extrusion.

Polymer Engineering and Science, June 1999, Vol. 39, No. 6, beginning on page 1087 discloses a TPV with an ethylene-octene dispersed in a polypropylene matrix. In a first step, the ethylene-octene polymers are coated and peroxide generation upon melting causes grafting (See Polymer Engineering and Science at page 1092). The polypropylene appropriately coated is added and blended in a second step. In a third step, water is injected to effect cross-linking. DE4402943 discloses a similar process.

PCT publication WO 98/23687 discloses thermoplastic polymer blend compositions that include a thermoplastic matrix resin phase that is substantially free of cross-linking and a dispersed silane-grafted elastomer phase.

It is among the objects of the invention to provide a simplified and/or flexible process by integrating blending and grafting and/or blending and curing.

### 3. SUMMARY OF THE INVENTION

In one embodiment, the present invention provides a process for making a thermoplastic vulcanizate (“TPV”) in a reactor. The process includes forming a mixture in which a silane grafted resilient polymer component is dispersed in a thermoplastic matrix component and adding a solid water-generating agent to crosslink the silane grafted elastomer component. The mixture is formed by mixing in the reactor: a) from 40 to 75 parts by weight of the matrix component, per 100 parts by weight of the matrix component and resilient polymer component combined, b) from 25 to 60 parts by weight of the resilient polymer component, per 100 parts by weight of the matrix component and resilient polymer component combined, and c) a silane grafting agent.

In another embodiment, the process includes a) blending a thermoplastic polymer component for forming a continuous matrix phase, a resilient polymer component, and a silane grafting agent for forming a phase dispersed in the matrix, and additives so as to promote silane grafting; and b) adding a solid water generating agent, which releases water, while the blend formed in step a) is submitted to shear so as to crosslink the silane grafted polymer.

In a particular aspect of any of the embodiments described herein, the process has one or more of the following characteristics, in any combination:
a) a continuous matrix phase having a crystallinity as determined by DSC of at least 40%;
b) a resilient polymer component having a crystallinity as determined by DSC of less than 40%;
c) the process further comprises mixing a free radical generator in the reactor;
d) the free radical generator is a peroxide;
e) the process further comprises mixing a hydrolysis catalyst in the reactor;
f) the silane grafting agent, free radical generator, and hydrolysis catalyst are added as individual components to the reactor;
g) the silane grafting agent, free radical generator, and hydrolysis catalyst are added to the reactor as a mixture on a porous carrier polymer;
h) the porous carrier polymer is selected from the group consisting of polyethylene and polypropylene;
i) the silane grafting agent is a vinylalkoxysilane;
j) the vinylalkoxysilane is selected from the group consisting of vinylmethoxysilane and vinylethoxysilane;
k) the solid water-generating agent is selected from the group consisting of a metal oxide/carboxylic acid combination, Epsom salt, Glauber's salt, clay, water, talc, and combinations thereof;
l) the matrix component comprises at least one of a polyolefin, a polyamide, and a polyester;
m) the resilient polymer component comprises at least one of halobutyl rubber, ethylene-propylene rubber, ethylene-propylene-diene terpolymer rubber, natural rubber, synthetic rubber, amine functionalized synthetic rubber, and epoxy functionalized synthetic rubber;
n) the resilient polymer component is an ethylene interpolymer;
o) the process includes mixing from 25 to 35 parts, or 30 parts, by weight of the resilient polymer component and from 65 to 75 parts, or 70 parts, by weight of the matrix component, per 100 parts by weight of the matrix component and resilient polymer component combined;
p) the reactor is a batch-type compounding apparatus;
q) the reactor is a continuous-type compounding apparatus;
r) the reactor is connected to a die suitable for extruding the product in the reactor into a shaped, fabricated product without an intervening pelletization step;
s) the matrix component has a crystallinity as determined by DSC of at least 40%;
t) the resilient polymer component has a crystallinity as determined by DSC of no more than 40%;
u) the crystallinity of the matrix component and the resilient polymer component differ by at least 10%, or at least 20%; and
v) the matrix component and the resilient polymer component are blended and simultaneously combined with the silane grafting agent.

### 4. BRIEF DESCRIPTION OF THE DRAWINGS

FIG. 1 is a graph of the thermogravimetric analysis of weight loss versus temperature for magnesium sulfate hepthydrate (Epsom salt).

FIG. 2 is a graph of the thermogravimetric analysis of weight loss versus temperature for sodium sulfate decahydrate (Glauber's salt).

FIG. 3 is a graph of the thermogravimetric analysis of weight loss versus temperature for talc.

FIG. 4 is a graph of the thermogravimetric analysis of weight loss versus temperature for hydrated clay (hydrous aluminum silicate).

FIG. 5 is the thermogravimetric analysis of weight loss versus temperature for a zinc oxide/stearic acid combination.

FIG. 6 is the thermogravimetric analysis of weight loss versus temperature for a zinc oxide/isononanoic acid combination.

FIG. 7 is the thermogravimetric analysis of weight loss versus temperature for a zinc oxide/isooctanoic acid combination.

FIG. 8 is a low voltage SEM micrograph of calendared sheeting.

### 5. DETAILED DESCRIPTION

Thermoplastic Matrix Component

The matrix component of the TPV comprises a thermoplastic, for example, polyolefins, polyamides, and polyesters. Suitable polymers for the matrix component are those polyolefinic thermoplastic polymers made by the polymerization of mono-olefin monomers using a high pressure, low pressure or intermediate pressure process with conventional Ziegler Natta and/or single site catalysts such as metallocenes. Preferably thermoplastic matrix component is a polyolefin in which the monoolefin monomers converted to repeat units are at least 95 wt % monoolefins of the formula CH₂═C(CH₃)—R or CH₂═CHR where R is a H or a linear or branched alkyl group of from 1 to 12 carbon atoms.

Suitable polymers for the matrix component include polyethylene, and ethylene interpolymers comprising as a comonomer an alpha olefin having from 3 to 10 carbon atoms, polypropylene, propylene interpolymers with comprising as a comonomer alpha olefins such as ethylene and alpha olefins having from 4 to 10 carbon atoms, as well as mixtures of two or more. The ethylene derived polymer can be either high density or low density. The term polypropylene is used to mean a homopolymer or copolymer or mixtures thereof. Generally, the higher the melting temperature of the matrix component the higher the potential temperature at which the TPV can be processed. The propylene polymer matrix component can be any propylene-based polymer, i.e., a polymer wherein a majority of units are derived from propylene.

In one embodiment, the matrix component is based on a propylene polymer which may be a propylene homopolymer, a copolymer or an impact copolymer. Generally, the propylene polymer may have a melt flow rate (MFR) of 15 or higher, and optionally an MFR of 25 or higher, or 35. Generally, the flexural modulus is at least 1000 MPa, or at least 1200 MPa, or 1300 MPa. The polypropylene polymer can be made using a multiple-site catalyst or a single-site catalyst such as a metallocene.

In one embodiment, the matrix component is an impact modified polypropylene. In this embodiment, the matrix component itself is a blend of a propylene polymer matrix with an uncrosslinked elastomer dispersed therein. In a particular aspect of this embodiment, the elastomer is a copolymer and is present in amount of less than 20 wt % based on the total weight of the impact modified polypropylene blend. In another particular aspect of this embodiment, the propylene polymer matrix component of the impact modified polypropylene is a polypropylene having a propylene content of at least 95 wt %, a weight average molecular weight of at least 70,000, and is highly stereoregular, with either isotactic or syndiotactic regularity.

The impact modified polypropylene may be prepared as a reactor blend wherein the propylene polymer portion and the elastomer portion are simultaneously formed by polymerization of propylene with another appropriate olefin comonomer in different zones or in a single reaction zone as is known in the art. Alternatively, the impact modified polypropylene may be formed by melt compounding of a polypropylene with an elastomer, each of which were separately formed prior to blending. Generally, for reasons of economy, impact modified polypropylenes are prepared as reactor blends and for this reason generally have an impact modifying elastomer content not exceeding 20 wt % of the reactor blend, and more typically not exceeding 12 wt % of the reactor blend. Further discussion of the particulars of an impact modified polypropylene may be found in U.S. Pat. No. 4,521,566, fully incorporated herein by reference. Regardless of how the impact modified polypropylene is formed, it generally comprises from 80 wt % to 90 wt % of a propylene polymer and from 10 wt % to 20 wt % of an elastomer such that the propylene content of the blend is at least 80 wt %. The impact modified polypropylenes of the present invention have a 1% secant modulus of from 60,000 psi to 130,000 psi, and a MFR within the range having an upper limit of 5.0 or 3 and a lower limit of 0.5.

In one embodiment, the matrix component is a thermoplastic polyamide composition. These generally comprise crystalline or resinous, high molecular weight solid polymers including copolymers and terpolymers having recurring polyamide units within the polymer chain. Polyamides may be prepared by polymerization of one or more epsilon lactams such as caprolactam, pyrrolidone, lauryllactam and aminoundecanoic lactam, or amino acid, or by condensation of dibasic acids and diamines. Both fiber forming and molding grade nylons are suitable. Examples of such polyamides are polycaprolactam (nylon 6), polylaurylactam (nylon 12), polyhexamethyleneadipamide (nylon 6,6), polyhexamethylene-azelamide (nylon 6,9), polyhexamethylenesebacamide (nylon 6,10), polyhexamethyleneisophthalamide (nylon 6,IP) and the condensation product of 11-aminoundecanoic acid (nylon 11); as well as partially aromatic polyamides made by polycondensation of meta xylene diamine and adipic acid. Furthermore, the polyamides may be reinforced, for example, by glass fibers or mineral fillers or mixtures thereof. Pigments, such as carbon black or iron oxide may also be added. Additional examples of polyamides are described in Kirk-Othmer, Encyclopedia of Chemical Technology, v. 10, page 919, and Encyclopedia of Polymer Science and Technology, Vol. 10, pages 392-414.

The matrix component is present in an amount within the range having an upper limit of 80, or 75, or 70, or 65 parts by weight, and a lower limit of 40 parts by weight, per 100 parts by weight of the matrix component and resilient polymer component combined. The resilient polymer component is present in an amount within the range having an upper limit of 60 parts by weight, and a lower limit of 35, or 30, or 25, or 20 by weight, per 100 parts by weight of the matrix component and resilient polymer component combined.

Resilient Polymer Component

The resilient polymer component generally comprises a polymer having elastomeric properties. Examples include rubbers, elastomers, and plastomers. The polymer may have residual unsaturation or curable functional sites that can react and be at least partially crosslinked with curing agents. Possible materials for the rubber component include halobutyl rubber, ethylene-propylene (EP) rubbers, ethylene-propylene-diene terpolymer (EPDM) rubbers, natural rubber, and synthetic rubbers such as synthetic polyisoprene, polybutadiene rubber, styrene-butadiene rubber, butadiene-acrylonitrile rubber. Also suitable are amine functionalized or epoxy functionalized synthetic rubbers. Examples of these include amine functionalized EPDM, epoxy functionalized natural rubber, and functionalized metallocene plastomer.

The resilient polymer component may be based on an ethylene interpolymer, i.e., ethylene-derived units are the major constituent by weight %. The ethylene interpolymers may have a density within the range having an upper limit of 0.915 g/cm³ or 0.910 g/cm³ and a lower limit of 0.860 g/cm³. The ethylene interpolymer may be prepared with a single sited catalyst, for example, a catalyst having a transition metal component which is an organometallic compound with at least one ligand which has a cyclopentadienyl anion structure through which the ligand coordinates to the transition metal cation. Preferably, the interpolymer has a narrow molecular weight distribution and narrow compositional distribution.

Metallocene-catalyzed ethylene interpolymers may be partially thermoplastic-like and partially elastomer-like, and are sometimes referred to as “plastomers.” The ethylene interpolymer may be a copolymer having, based on total monomer content, from 85 mole % to 96 mole % ethylene-derived units and 4 mole % to 15 mole % units derived from alpha-olefin comonomer. The alpha-olefin comonomer is incorporated in an amount that provides for a density of from 0.915 g/cm³ to 0.860 g/cm³. The alpha-olefin comonomer of the plastomer may be an acyclic monoolefin, such as butene-1, pentene-1, hexene-1, octene-1, and 4-methyl-pentene-1.

The resilient polymer component may be based on an ethylene-alpha-olefin-diene terpolymer. Incorporation of certain amounts of diene monomer provides the resilient polymer component with further residual unsaturation to allow further functionalization and/or cross-linking reactions or coupling of the resilient polymer component in the final product. However, the invention can also be practiced to give satisfactory results when the resilient polymer component is an ethylene interpolymer substantially free of dienes.

The ethylene interpolymers may be characterized by one or more of the following:
(a) a DSC melting point curve that exhibits the occurrence of a single melting point peak occurring in the region of 40° C. to 110° C. (second melt rundown);
(b) a weight average molecular weight value in the range of 70,000 to 130,000;
(c) a molecular weight distribution (Mw/Mn) value of 4.0 or less, or 3.5 or less; and
(d) a 1% secant modulus not exceeding 15,000 and as low as 800 psi or less.

The resilient polymer component may be an EXACT™ plastomer, available from ExxonMobil Chemical Company of Baytown, Tex. EXACT™ plastomers are copolymers of ethylene and a C₄-C₈ alpha-olefin comonomer and have a plastic-like molecular weight.

The resilient polymer component may be an Engage™ polymer. Engage™ polymers are metallocene-catalyzed plastomers, available from Dow Chemical Company of Midland, Mich.

The resilient polymer component may comprise two or more polymers. For example, the resilient polymer component may comprise (a) an ethylene copolymer having a C₄-C₈ alpha-olefin comonomer and a plastic-like molecular weight, such as the EXACT™ plastomers described above, and (b) an ethylene-propylene-diene (“EPDM”) terpolymer. The EPDM of (b) may be a low crystallinity EPDM present in the resilient polymer component in an amount within the range having an upper limit of 75 wt % or 70 wt % and a lower limit of 50 wt % or 60 wt %, based on the total weight of the resilient polymer component, and having a density within the range having an upper limit of 0.90 g/cm³, or 0.880 g/cm³ and a lower limit of 0.860 g/cm³. By low crystallinity EPDM, it is meant that the EPDM has a heat of fusion less than 10 J/g, as determined by DSC. The low crystallinity EPDM may be Vistalon™ 7500, available from ExxonMobil Chemical Company of Baytown, Tex. Vistalon™ 7500 is a low crystallinity EPDM terpolymer having an ethylene content of 52.3 wt % and a heat of fusion of 0.6 J/g.

Alternatively, the EPDM of component (b) may be a high crystallinity EPDM present in the resilient polymer component in an amount within the range having an upper limit of 60 wt % or 50 wt % and a lower limit of 20 wt % or 25 wt %, based on the total weight of the resilient polymer component. By high crystallinity EPDM, it is meant that the EPDM has an ethylene content of more than 70 wt % and a heat of fusion more than 10 J/g, as measured by DSC. The high crystallinity EPDM may be Vistalon™ 1703P, available from ExxonMobil Chemical Company of Baytown, Tex. Vistalon™ 7500 is a high crystallinity EPDM having an ethylene content of 78% and a vinyl norbornene content of 0.9 wt %.

The rubber component may further comprise a halogenated copolymer of isomonoolefin and alkylstyrene as described in U.S. Pat. Nos. 5,162,445 and 6,207,754, both fully incorporated herein by reference. The halogenated copolymer may be a copolymer of a C₄ to C₇ isomonoolefin and an alkylstyrene. The isomonoolefin may be isobutylene, the alkylstyrene may be halogenated methylstyrene, and the halogen may be bromine. The halogenated copolymer may be produced by halogenating an isobutylene-alkylstyrene copolymer using bromine in normal alkane (e.g., hexane or heptane) solution utilizing a bis azo initiator, e.g., AIBN or VAZO 52 (2,21-azobis(2,4 dimethylpentane nitrile)), at 55° C. to 80° C. for a time period ranging from 4.5 to 30 minutes, followed by a caustic quench. The recovered polymer is then washed in basic water wash and water/isopropanol washes, recovered, stabilized and dried.

Crosslinking

One common method of crosslinking involves the use of peroxide to form carbon to carbon bonds to crosslink the resilient polymer component. When the matrix component comprises polypropylene, however, the peroxide degrade the polypropylene matrix in addition to crosslinking the resilient polymer component. Thus, it is desirable to use a chemical agent that will significantly crosslink the elastomer component, such as a vinylalkoxysilane. Vinyltrimethoxysilane (VTMOS) and vinyltriethoxysilane (VTEOS) are specific examples of vinylalkoxysilanes. Vinylalkoxysilanes can be used in conjunction with a very small amount of peroxide, i.e., a ratio of vinylalkoxysilane/peroxide of from 10/1 to 40/1. The peroxide can be selected to be reactive at a low temperature during the initial blending. The peroxide is used as a free radical generator to graft the vinylsilane molecules onto the elastomer backbone, as shown below.

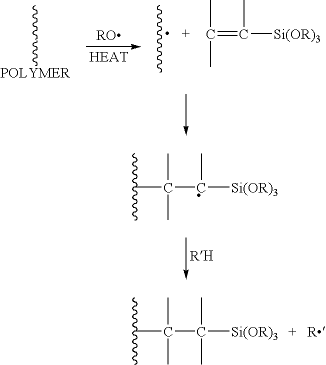

The invention can be practiced by adding to the compounding apparatus, during the grafting stage, the silane and optionally a free radical generator and hydrolysis catalyst as individual components, or as a mixture.

The silane may be fed into the compounding apparatus via a solid carrier polymer which is compatible with the base polymer. Such a process is described in U.S. Pat. No. 5,112,919, fully incorporated herein by reference, which provides a process for adding a solid feed of silane crosslinking agent into an extruder, as opposed to liquid silane.

The silane may be fed as a “silane masterbatch” into the compounding apparatus. The term “silane masterbatch” as used herein refers to a mixture of a vinylalkoxysilane, a small amount of free radical generator, and a hydrolysis catalyst on a solid carrier polymer. Two types of silane masterbatch are commercially available. One type is based on a porous polyethylene carrier, and the other type is based on a porous polypropylene carrier. The polypropylene carrier may be a homopolypropylene, impact copolymer of propylene, or random copolymer of propylene. Polypropylene random copolymers are not preferred because vinylsilane will graft onto the ethylene linkages along the backbone of the polypropylene random copolymer and crosslink both the carrier as well as the elastomer.

Engineering resins, such as polyamide and polyesters, may also be used as the carrier in order to increase the high temperature resistance of the TPV. Maleic anhydride grafted plastomers or maleic anhydride grafted EP rubber or EPDM can be used as a compatibilizer between the engineering resin and the resilient polymer component. Peroxide and vinylsilane can also be used as the carrier.

When the silane grafting reaction is complete, a water-generating agent releases water upon heating, and preferably at the melting temperature range of the polymers, inside the compounding equipment, which enables the crosslinking to occur. The water-generating agent can be added to the reactor upon completion of the silane grafting reaction. Examples of water-generating agents include Epsom salt, Glauber's salt, clay, water, talc, metal oxide/carboxylic acid combinations, and combinations thereof. Examples of metal oxide/carboxylic acid combinations are zinc oxide/stearic acid, zinc oxide/isononaioc acid, and zinc oxide isooctanoic acid.

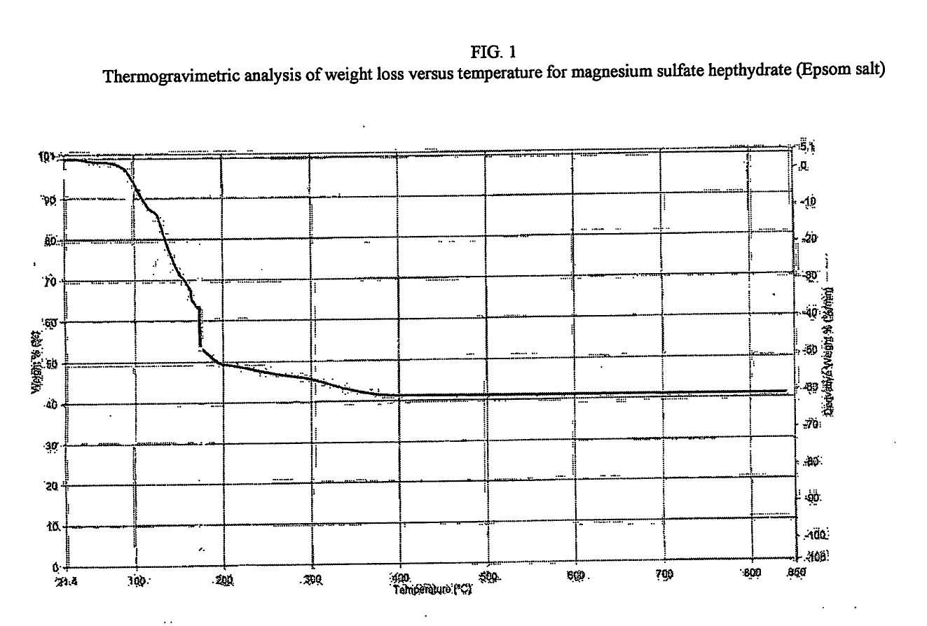

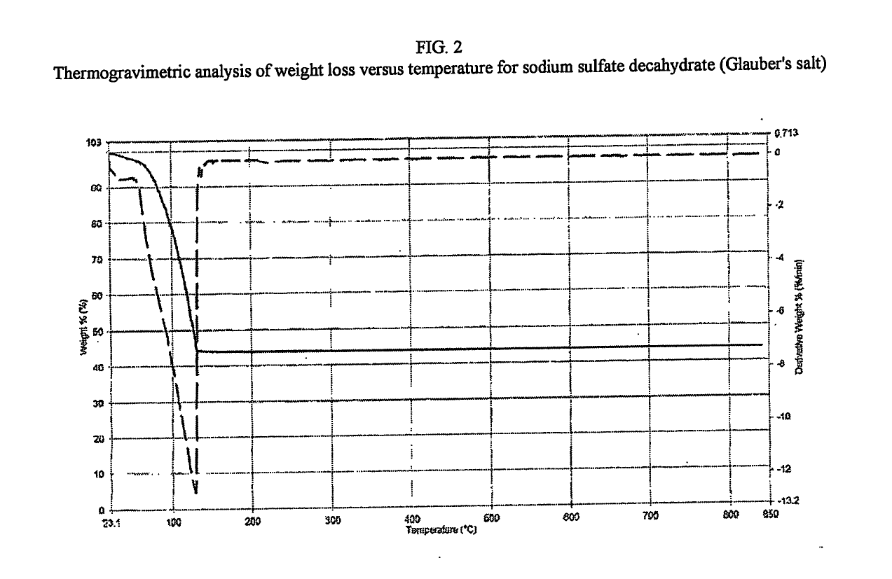

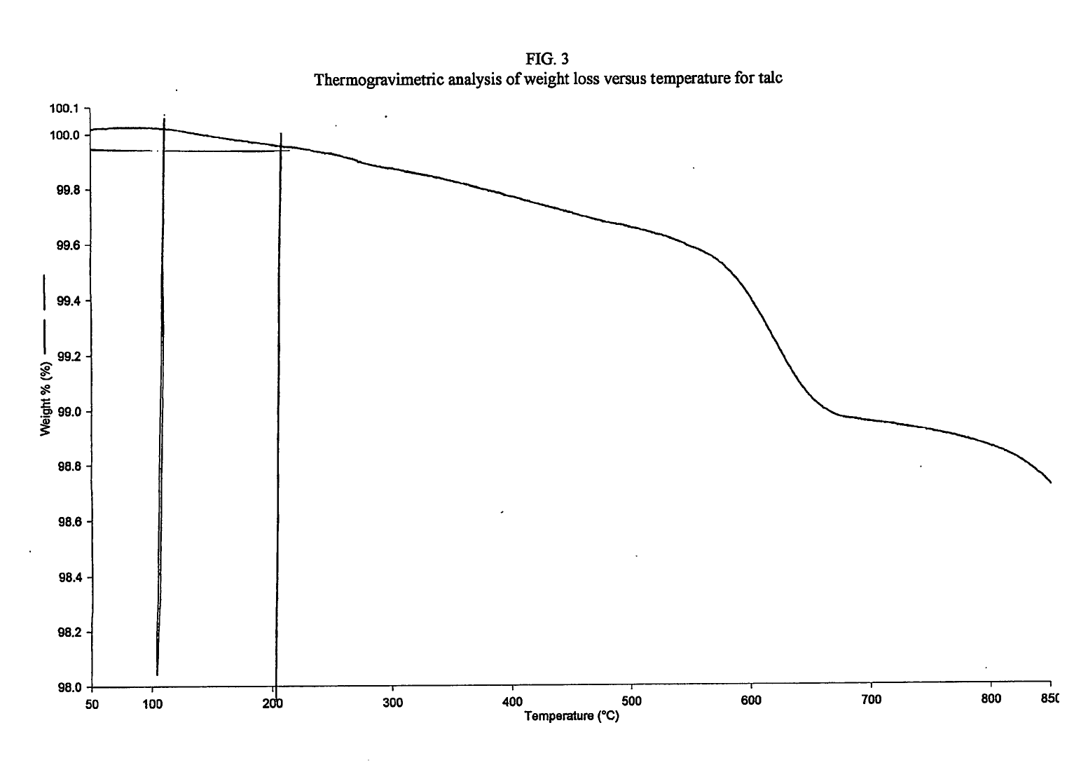

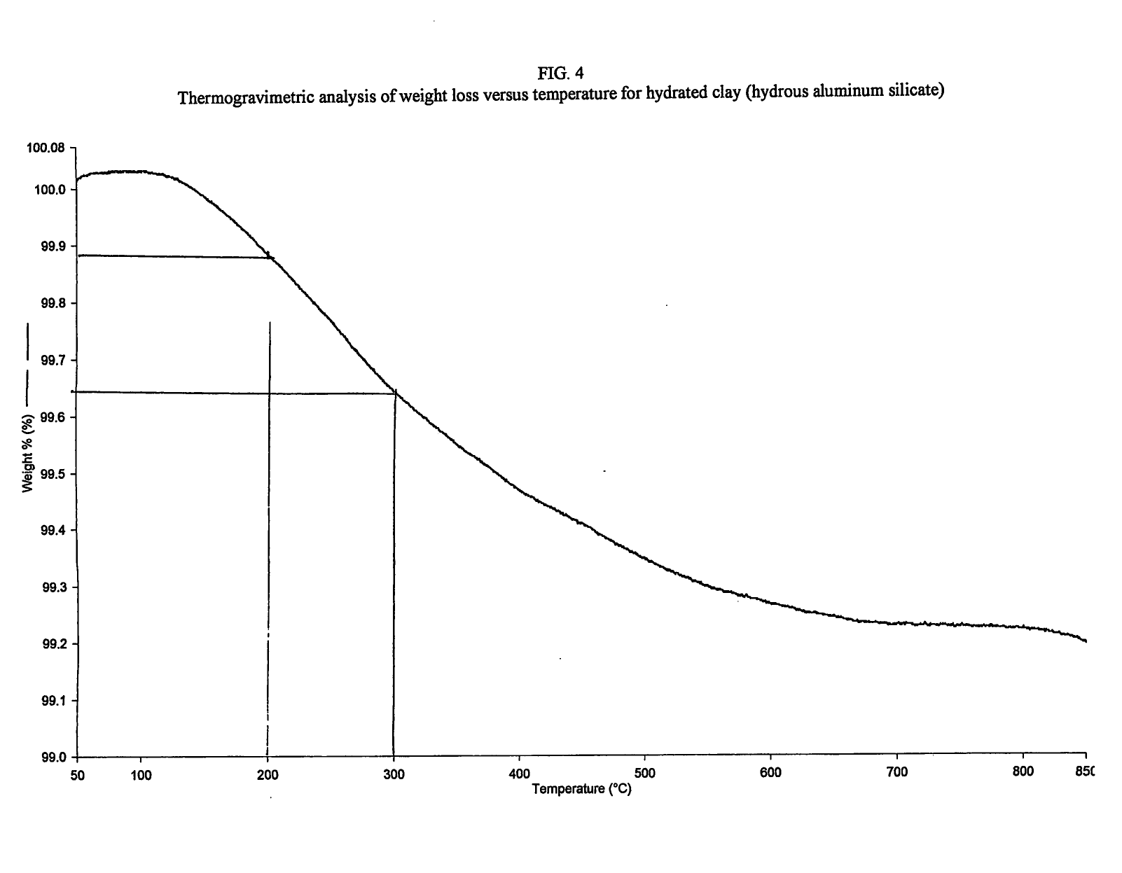

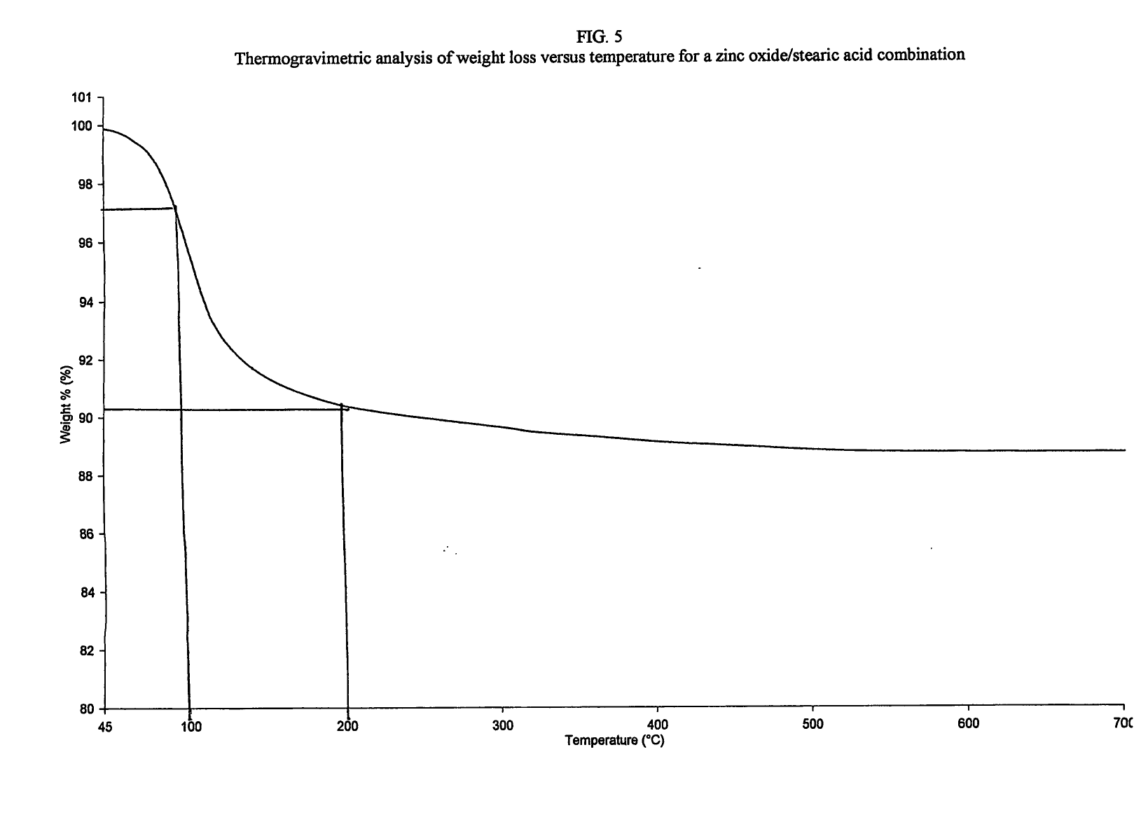

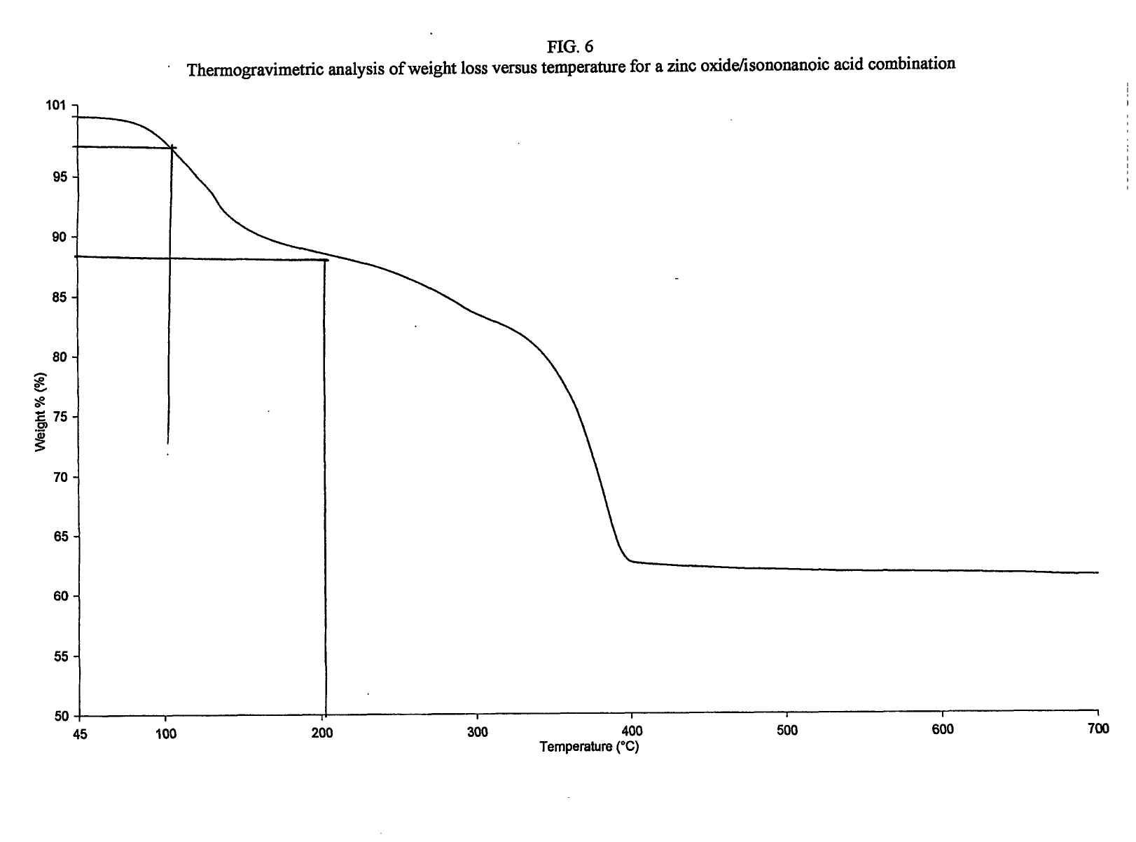

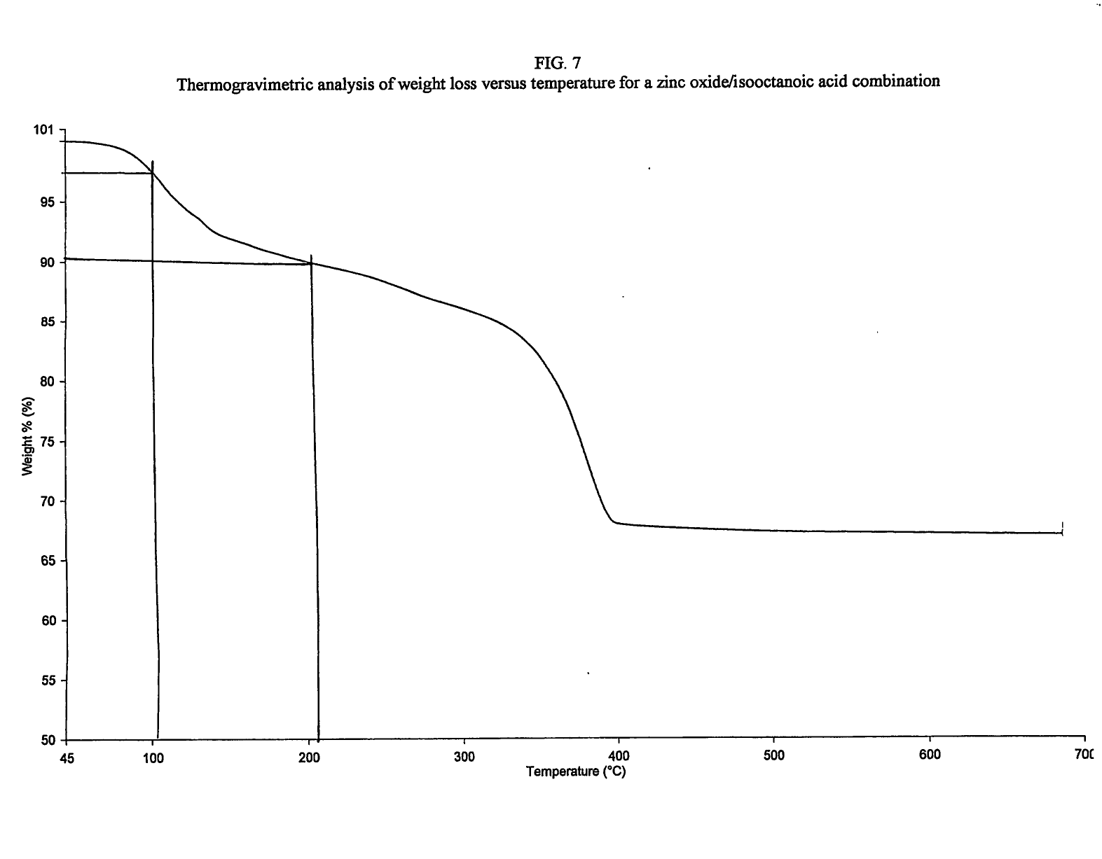

FIGS. 1 and 2 illustrate the thermogravimetric analysis of weight loss versus temperature for magnesium sulfate hepthydrate (Epsom salt), and sodium sulfate decahydrate (Glauber's salt), respectively. The figures show that Epsom salt releases half of its hydrated water at 150° C. to 200° C. and Glauber's salt releases half of its hydrated water at a much lower temperature. FIGS. 3-7 illustrate the thermogravimetric analysis of weight loss versus temperature for talc, hydrated clay (hydrous aluminum silicate), and several metal oxide/carboxylic acid combinations (zinc oxide/stearic acid, zinc oxide/isononanoic acid, and zinc oxide/isooctanoic acid).

In the presence of water molecules, the OR groups of the grafted vinylsilane molecules can be easily hydrolyzed into OH groups. The Si—OH groups can then undergo a condensation reaction in the presence of a hydrolysis catalyst, for example dibutyltin dilaurate, to form Si—O—Si linkages. When there are not enough vinylsilane molecules grafted onto the elastomer backbone, the Si—O—Si linkages provide two dimensional chain extensions from the elastomer molecules. When there are enough vinylsilane molecules grafted onto the elastomer backbone, a three dimensional network can be formed, and the elastomers are crosslinked. The crosslinking process described above is shown below.

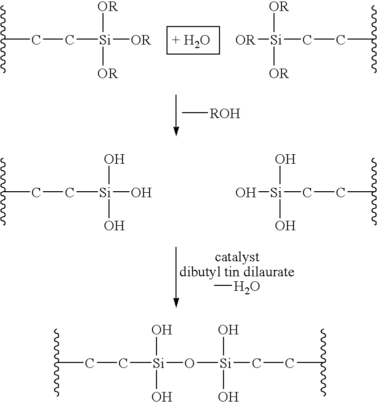

The invention can be practiced without a subsequent vulcanization step, because the addition of the water-generating agent to the compounding apparatus allows the TPV to be crosslinked before emerging from the compounding line. In the case of a batch mixer, after completing the grafting reaction, the feed ram is raised and the water-generating agent is added. The mixing is then continued inside the mixer until the vulcanization reaction is complete. Alternatively, a continuous mixer, e.g. an extruder, can be used as the compounding apparatus. In a one-pass process, the water-generating agent is added to the extruder at a point downstream of the region where the silane grafting reaction occurs. In a two-pass process, the silane grafting occurs in the first pass, and the crosslinking reaction is completed by adding the water-generating agent in a second pass on the same extruder.

By appropriate process conditions, the degree of crosslinking, i.e. gel content, may be substantially the same for the entire compound. This is an advantage over processes in which an article is crosslinked by subjecting the compounded article to water after emerging from the compounding line, which causes the degree of crosslinking to depend on the thickness of the article.

Other Ingredients

The TPVs of the present invention may be modified by adding conventional ingredients known in the art. Such ingredients include, but are not limited to particulate fillers, clay, pigments, reinforcing agents, stabilizers, antioxidants, flame retardants, tackifiers, plasticizers, waxes, processing oils, lubricants, foaming agents, and extender oils. These additional ingredients can comprise up to about 50 weight percent of the total composition. Those of skill in the art will appreciate that other additives may be used to enhance properties of the TPV.

Apparatus

The TPVs of the present invention can be prepared using any suitable batch-mixing apparatus (e.g., Banbury mixer) or continuous apparatus (e.g., a single screw or twin screw extruder).

### EXAMPLES

The present invention is illustrated hereinafter in more detail with reference to the following examples, which should not be construed as to limit the scope of the present invention. Table 1 provides a list of the test methods used in the examples.

In the following examples, Escorene™ PP 1105 is a propylene homopolymer having a melt flow rate of 35, a flexural modulus (MPa) of 1300, and a Notched Izod Impact (@23° C. KJ/m²) of 3.2. Escorene™ PP 8191 is an impact modified polypropylene having a density of 0.9 g/cm³, a melt flow rate of 1 dg/min, an ethylene comonomer content of 20 wt %, a 1% secant modulus of 62,500 psi and a DSC peak melting point of 141.6° C. Capron™ CA 73 ZP is a polyamide-6 resin from Honeywell, Morristown, N.J. Ultamid 35 is a polyamide 6,66 copolymer from BASF, Freeport, Tex. Pebax 3533 is a flexible polyamide from Atofina Chemical, Philadelphia, Pa. Sunpar 150 HT is a processing oil from Sun Oil, Marcus Hook, Pa. Exact™ 8201 is an ethylene-octene copolymer having a melt index of 1.1 g/10 min, a density of 0.882 g/cm³, a flexural modulus 1% secant of 3300 psi, a Mooney viscosity (1+4 @125° C.) of 19, a peak melting temperature of 66.7° C., and a melt flow rate of 2.5 g/10 min. Exact™ 4033 is an ethylene-butene copolymer having a density of 0.880 g/cm³, a melt index of 0.8 dg/10 min., a flexural modulus 1% secant of 3300 psi, a Mooney viscosity (1+4 @125° C.) of 28 and a DSC peak melting point of 60° C. Vistalon™ 1703P is a high crystallinity EPDM containing about 0.9 wt % vinyl norbornene and 78 wt % ethylene. Vistalon™ 3666 is an oil extended low crystalline EPDM with 0 J/g heat of fusion. Vistalon™ 9303H is another low crystalline EPDM having a 3.7 J/g heat of fusion. Exxpro™ 89-1 is a brominated polymer derived from a copolymer of isobutylene and methylstyrene. Exxpro™ 89-1 has a density of 0.93 g/cm³, a Mooney viscosity of 35 ML (1+8) @ 125° C. and a bromine wt % of 1.2. Escorene™, Exact™, Vistalon™ and Exxpro™ are products available from ExxonMobil Chemical Company. Silane masterbatch #1 was supplied by OSI Specialties, Crompton Corporation, Tarrytwon, N.J., under the designation of XL-Pearl Y-15307, which comprises 70 wt % of a silane mixture absorbed into 30 wt % porous polypropylene. The majority of the silane mixture comprises a VTMOS type of silane with grafting peroxide and hydrolysis catalyst added. Silane masterbatch #2, also supplied by OSI Specialties comprises 50 wt % of a silane mixture absorbed into 50 wt % porous polyethylene. The majority of the silane mixture comprises a VTMOS type of silane. Silane masterbatch #3, also supplied by OSI comprises 70 wt % of a silane mixture absorbed into 30 wt % porous polypropylene. The majority of the silane mixture comprises a VTEOS type of silane. A commercial supplier of porous carrier is Accurel Systems, Akzo Nobel Membrana Gmbh, Obemburg, Germany.

TABLE 1

| | Test Method |
|---|---|
| Melt Flow Rate | ASTM D1238 |
| Shore Hardness | ASTM D2240 |
| Conditioning of Test Specimens | ASTM D618 |
| Tensile Strength | ASTM D638 |
| Tensile Modulus | ASTM D638 |
| Ultimate Elongation | ASTM D638 |
| Flexural Modulus | ASTM D790 |
| DSC Peak Melting Point | ASTM D3417 |
| Gel Content | ASTM D-2765 |
| Compression Set | ASTM D-395 |

### Example 1

### Banbury Mixer; Silane Masterbatch #1

In Samples 1-5, various amounts of silane masterbatch #1 (VTMOS type silane absorbed on a porous polypropylene carrier) were added to 30/70 blends of Escorene™ PP 1105/Exact™ 8201 and the mixture melt mixed in a 0° C. size Banbury mixer to perform a silane grafting reaction. A batch weight of 2270 grams was used. After the silane grafting reaction was completed, as indicated by a motor torque increase, the feed ram was raised, and 0.2 parts of Epsom salt per hundred parts of resin was added. The ram was then lowered until another torque increase was observed. In order to prevent the material from being heated up to above 500° F., the mixer was shifted to a lower rotor speed to complete the crosslinking reaction.

TABLE 2

| | Sample 1 | Sample 2 | Sample 3 | Sample 4 | Sample 5 |
|---|---|---|---|---|---|
| Composition | | | | | |
| Escorene ™ PP 1105 | 30 | 30 | 30 | 30 | 30 |
| (parts per 100 parts of | | | | | |
| Escorene ™ PP 1105 and | | | | | |
| EXACT ™ 8201 combined) | | | | | |
| EXACT ™ 8201 | 70 | 70 | 70 | 70 | 70 |
| (parts per 100 parts of | | | | | |
| Escorene ™ PP 1105 and | | | | | |
| EXACT ™ 8201 combined) | | | | | |
| Silane Masterbatch #1 | 1.5 | 2 | 2.5 | 3 | 3.5 |
| (parts per 100 parts of | | | | | |
| Escorene ™ PP 1105 and | | | | | |
| EXACT ™ 8201 combined) | | | | | |
| Epsom Salt | 0.2 | 0.2 | 0.2 | 0.2 | 0.2 |
| (parts per 100 parts of | | | | | |
| Escorene ™ PP 1105 and | | | | | |
| EXACT ™ 8201 combined) | | | | | |
| Property | | | | | |
| Hardness (Shore D) | | | | | |
| @ 0 sec Elapsed Time | 47 | 47 | 49 | 49 | 48 |
| @ 15 sec Elapsed Time | 43 | 43 | 44 | 44 | 42 |
| Tensile Stress (psi) | | | | | |
| 100% Modulus | 1337 | 1272 | 1267 | 1165 | 1187 |
| 200% Modulus | 1464 | 1421 | 1445 | 1324 | 1375 |
| 300% Modulus | 1556 | 1548 | 1598 | 1472 | 1549 |
| Ultimate | 2497 | 2297 | 2207 | 2322 | 2293 |
| Ultimate Elongation (%) | 1167 | 832 | 665 | 742 | 663 |
| Flexural Modulus (psi) | | | | | |
| Tangent | 19804 | 19163 | 16369 | 15791 | 15257 |
| 1% Secant | 19308 | 18561 | 15994 | 15360 | 14840 |
| Tear Strength (lb/in) | | | | | |
| @ Max Load | 484.4 | 418 | 364.8 | 341.7 | 348.8 |
| @ Break | 241 | 249.5 | 214.6 | 173.6 | 248.9 |
| Compression Set (%) | | | | | |
| @ 70° C. & 22 hrs | 83 | 77 | 74 | 70 | 72 |
| Xylene Extractables (%) | 31.97 | 46.24 | 50.3 | 59.77 | 59.82 |

### Example 2

### Twin Screw Extruder; Silane Masterbatch #1

Samples 6-11 of Table 3 illustrate TPVs having a propylene homopolymer matrix component and an ethylene based copolymer rubber component produced by a continuous mixer, as described in detail below. The same resin mixture of Escorene™ PP 1105/Exact™ 8201 as described in Example 1, together with the VTMOS masterbatch on a porous polypropylene carrier is first melt compounded using a 30 mm ZSK twin screw extruder to complete the silane grafting reaction. In a second pass, the melt blended compound together with Epsom salt was compounded on the same ZSK extruder to complete the crosslinking reaction.

TABLE 3

| | Sample 6 | Sample 7 | Sample 8 | Sample 9 | Sample 10 | Sample 11 |
|---|---|---|---|---|---|---|
| Composition | | | | | | |
| Escorene ™ PP 1105 | 30 | 30 | 30 | 30 | 30 | 30 |
| (parts per 100 parts of | | | | | | |
| Escorene ™ PP 1105 and | | | | | | |
| EXACT ™ 8201 | | | | | | |
| combined) | | | | | | |
| Exact ™ 8201 | 70 | 70 | 70 | 70 | 70 | 70 |
| (parts per 100 parts of | | | | | | |
| Escorene ™ PP 1105 and | | | | | | |
| EXACT ™ 8201 | | | | | | |
| combined) | | | | | | |
| Silane Masterbatch #1 | 2 | 2.5 | 3 | 3.5 | 4 | 4.5 |
| (parts per 100 parts of | | | | | | |
| Escorene ™ PP 1105 and | | | | | | |
| EXACT ™ 8201 | | | | | | |
| combined) | | | | | | |
| Epsom Salt | 0.2 | 0.2 | 0.2 | 0.2 | 0.2 | 0.2 |
| (parts per 100 parts of | | | | | | |
| Escorene ™ PP 1105 and | | | | | | |
| EXACT ™ 8201 | | | | | | |
| combined) | | | | | | |
| Property | | | | | | |
| Hardness (Shore D) | | | | | | |
| @ 0 sec Elapsed Time | 47 | 46 | 46 | 45 | 47 | 46 |
| @ 15 sec Elapsed Time | 42 | 41 | 42 | 40 | 42 | 40 |
| Tensile Stress (psi) | | | | | | |
| 100% Modulus | 1267 | 1180 | 1221 | 1190 | 1224 | 1248 |
| 200% Modulus | 1387 | 1325 | 1395 | 1460 | 1497 | 1545 |
| 300% Modulus | 1477 | 1448 | 1542 | 1698 | 1674 | 1751 |
| Ultimate | 2500 | 2400 | 2462 | 1766 | 1870 | 1893 |
| Ultimate Elongation (%) | 1142 | 923 | 879 | 345 | 369 | 346 |
| Flexural Modulus (psi) | | | | | | |
| Tangent | 18466 | 17703 | 16547 | 15701 | 15725 | 15383 |
| 1% Secant | 18442 | 17501 | 16523 | 15310 | 15482 | 15222 |
| Tear Strength (lb/in) | | | | | | |
| @ Max Load | 444 | 397 | 392 | 356 | 349 | 342 |
| @ Break | 265 | 216 | 218 | 217 | 224 | 202 |
| Compression Set (%) | | | | | | |
| @ 70° C. & 22 hrs | 80 | 78 | 72 | 76 | 66 | 66 |
| Vicat Softening Point | | | | | | |
| @ 1000 g | 74.9 | 75.3 | 75.8 | 86.4 | 86.8 | 97.1 |
| Xylene Extractables (%) | 39.12 | 52.62 | 54.24 | 63.83 | 64.56 | 65.4 |

### Example 3

### Banbury Mixer; Silane Masterbatch #2

In Samples 12-16, various amounts of VTMOS masterbatch on a porous polyethylene carrier (from 1.5 parts per hundred to 3.5 parts per hundred resin) were added to 30/70 blends of Escorene™ PP 1105/Exact™ 8201 and the mixture melt mixed in a 00C size Banbury mixer to perform a silane grafting reaction. A batch weight of 2270 grams was used. After the silane grafting reaction was completed, as indicated by a motor torque increase, the feed ram was raised, and 0.2 parts of Epsom salt per hundred parts of resin was added. The ram was then lowered until another torque increase was observed. In order to prevent the material from being heated up to above 500° F., the mixer was shifted to a lower rotor speed to complete the crosslinking reaction.

TABLE 4

| | Sample 12 | Sample 13 | Sample 14 | Sample 15 | Sample 16 |
|---|---|---|---|---|---|
| Composition | | | | | |
| Escorene ™ PP 1105 | 30 | 30 | 30 | 30 | 30 |
| (parts per 100 parts of | | | | | |
| Escorene ™ PP 1105 and | | | | | |
| EXACT ™ 8201 combined) | | | | | |
| EXACT ™ 8201 | 70 | 70 | 70 | 70 | 70 |
| (parts per 100 parts of | | | | | |
| Escorene ™ PP 1105 and | | | | | |
| EXACT ™ 8201 combined) | | | | | |
| Silane Masterbatch #2 | 1.5 | 2 | 2.5 | 3 | 3.5 |
| (parts per 100 parts of | | | | | |
| Escorene ™ PP 1105 and | | | | | |
| EXACT ™ 8201 | | | | | |
| combined) | | | | | |
| Epsom Salt | 0.2 | 0.2 | 0.2 | 0.2 | 0.2 |
| (parts per 100 parts of | | | | | |
| Escorene ™ PP 1105 and | | | | | |
| EXACT ™ 8201 | | | | | |
| combined) | | | | | |
| Property | | | | | |
| Hardness (Shore D) | | | | | |
| @ 0 sec Elapsed Time | 48 | 47 | 49 | 47 | 47 |
| @ 15 sec Elapsed Time | 43 | 43 | 45 | 43 | 43 |
| Tensile Stress (psi) | | | | | |
| 100% Modulus | 1309 | 1250 | 1267 | 1155 | 1161 |
| 200% Modulus | 1333 | 1339 | 1381 | 1245 | 1243 |
| 300% Modulus | 1359 | 1401 | 1466 | 1324 | 1317 |
| Ultimate | 2503 | 2435 | 2434 | 2442 | 2477 |
| Ultimate Elongation (%) | 1373 | 1287 | 1223 | 1129 | 1201 |
| Flexural Modulus (psi) | | | | | |
| Tangent | 25211 | 21845 | 24782 | 20444 | 20432 |
| 1% Secant | 23894 | 20965 | 23395 | 19567 | 19861 |
| Tear Strength (lb/in) | | | | | |
| @ Max Load | 506.2 | 517.3 | 500.7 | 439.3 | 480.1 |
| @ Break | 245.7 | 265.9 | 287.6 | 258.7 | 280.3 |
| Tension Set (%) | | | | | |
| @200% & min. | 69 | 67 | 63 | 69 | 69 |
| Compression Set (%) | | | | | |
| @ 70° C. & 22 hrs | 72 | 80 | 84 | 74 | 82 |
| Vicat Softening Point | | | | | |
| @1000 g | 75.8 | 79.7 | 81.5 | 78.7 | 74.9 |
| Xylene Extractables (%) | 0.265 | 22.17 | 23.69 | 36.23 | 35.75 |

### Example 4

### Twin Screw Extruder, Silane Masterbatch #2

Samples 17-24 of Table 5 illustrate TPVs having a propylene homopolymer matrix component and an ethylene based copolymer rubber component produced by a continuous mixer, as described in detail below. The same resin mixture of Escorene™ PP 1105/Exact™ 8201 as described in Example 1, together with the VTMOS masterbatch on a porous polyethylene carrier is first melt compounded using a 30 mm ZSK twin screw extruder to complete the silane grafting reaction. In a second pass, the melt blended compound together with Epsom salt was compounded on the same ZSK extruder to complete the crosslinking reaction.

TABLE 5

| | Sample | Sample | Sample | Sample | Sample | Sample | Sample | Sample |
|---|---|---|---|---|---|---|---|---|
| | 17 | 18 | 19 | 20 | 21 | 22 | 23 | 24 |
| Composition | | | | | | | | |
| Escorene ™ PP 1105 | 30 | 30 | 30 | 30 | 30 | 30 | 30 | 30 |
| (parts per 100 parts of | | | | | | | | |
| Escorene ™ PP 1105 | | | | | | | | |
| and EXACT ™ 8201 | | | | | | | | |
| combined) | | | | | | | | |
| Exact ™ 8201 | 70 | 70 | 70 | 70 | 70 | 70 | 70 | 70 |
| (parts per 100 parts of | | | | | | | | |
| Escorene ™ PP 1105 | | | | | | | | |
| and EXACT ™ 8201 | | | | | | | | |
| combined) | | | | | | | | |
| Silane Masterbatch #2 | 0.5 | 1 | 2 | 2.5 | 3 | 3.5 | 4 | 4.5 |
| (parts per 100 parts of | | | | | | | | |
| Escorene ™ PP 1105 | | | | | | | | |
| and EXACT ™ 8201 | | | | | | | | |
| combined) | | | | | | | | |
| Epsom Salt | 0.2 | 0.2 | 0.2 | 0.2 | 0.2 | 0.2 | 0.2 | 0.2 |
| (parts per 100 parts of | | | | | | | | |
| Escorene ™ PP 1105 | | | | | | | | |
| and EXACT ™ 8201 | | | | | | | | |
| combined) | | | | | | | | |
| Property | | | | | | | | |
| Hardness (Shore D) | | | | | | | | |
| @ 0 sec Elapsed Time | 45 | 46 | 47 | 47 | 45 | 47 | 48 | 48 |
| @ 15 sec Elapsed Time | 40 | 41 | 42 | 42 | 41 | 42 | 43 | 42 |
| Tensile Stress (psi) | | | | | | | | |
| 100% Modulus | 1232 | 1294 | 1329 | 1356 | 1303 | 1190 | 1229 | 1257 |
| 200% Modulus | 1211 | 1373 | 1418 | 1458 | 1424 | 1324 | 1411 | 1477 |
| 300% Modulus | 1230 | 1425 | 1472 | 1518 | 1499 | 1447 | 1570 | 1666 |
| Ultimate | 2657 | 2320 | 2517 | 2561 | 2472 | 2254 | 2130 | 2092 |
| Ultimate Elongation (%) | 1484 | 1205 | 1324 | 1331 | 1240 | 767 | 619 | 537 |
| Flexural Modulus (psi) | | | | | | | | |
| Tangent | 28973 | 24963 | 22105 | 21413 | 20437 | 19973 | 18123 | 18662 |
| 1% Secant | 28622 | 24252 | 21840 | 21253 | 20284 | 19257 | 17881 | 18248 |
| Tear Strength (lb/in) | | | | | | | | |
| @ Max Load | 525 | 587 | 504 | 527 | 504 | 401 | 386 | 392 |
| @ Break | 273 | 343 | 263 | 279 | 264 | 224 | 211 | 258 |
| Tension Set (%) | | | | | | | | |
| @200% & 5 min. | 75 | 65 | 73 | 68 | 64 | 60 | 56 | 44 |
| Compression Set (%) | | | | | | | | |
| @ 70° C. & 22 hrs | 91 | 85 | 81 | 81 | 78 | 77 | 74 | 74 |
| Vicat Softening Point | | | | | | | | |
| @ 1000 g | 74.9 | 76.1 | 77.6 | 77.3 | 78.6 | 81.1 | 80 | 84.8 |
| Xylene Extractables (%) | 0.22 | 0.23 | 0.12 | 1.69 | 33.72 | 51.62 | 54.15 | 55.45 |

### Example 5

### Silane Masterbatch #3

In Samples 25-28, various amounts of vinylethoxysilane (VTEOS) masterbatch on a porous polypropylene carrier (from 0.5 parts per hundred to 2 parts per hundred resin) were added to 30/70 blends of Escorene™ PP 1105/Exact™ 8201 and the mixture melt mixed in a 00C size Banbury mixer to perform a silane grafting reaction. A batch weight of 2270 grams was used. After the silane grafting reaction was completed, as indicated by a motor torque increase, the feed ram was raised, and 0.2 parts of Epsom salt per hundred parts of resin was added. The ram was then lowered until another torque increase was observed. In order to prevent the material from being heated up to above 500° F., the mixer was shifted to a lower rotor speed to complete the crosslinking reaction.

The results show that the gel levels achieved with VTEOS are far less than with the corresponding VTMOS shown in Example 1.

TABLE 6

| | Sample | | | Sample |
|---|---|---|---|---|
| Composition | 25 | Sample 26 | Sample 27 | 28 |
| Escorene ™ PP 1105 | 30 | 30 | 30 | 30 |
| (parts per 100 parts of | | | | |
| Escorene ™ PP 1105 and | | | | |
| EXACT ™ 8201 combined) | | | | |
| EXACT ™ 8201 | 70 | 70 | 70 | 70 |
| (parts per 100 parts of | | | | |
| Escorene ™ PP 1105 and | | | | |
| EXACT ™ 8201 combined) | | | | |
| Silane Masterbatch #3 | 0.5 | 1 | 1.5 | 2.0 |
| (parts per 100 parts of | | | | |
| Escorene ™ PP 1105 and | | | | |
| EXACT ™ 8201 combined) | | | | |
| Epsom Salt | 0.2 | 0.2 | 0.2 | 0.2 |
| (parts per 100 parts of | | | | |
| Escorene ™ PP 1105 and | | | | |
| EXACT ™ 8201 combined) | | | | |
| Xylene Insolubles (%) | 0.06 | 0.06 | 0.06 | 7.26 |

### Example 6

Samples 29-34 illustrate TPVs having a propylene homopolymer matrix component, and a rubber component comprising a combination of a metallocene plastomer and a low crystallinity EPDM rubber. Each of these compositions shows only a polypropylene melting peak by DSC, and no secondary low temperature peak was observed. Also in Sample 31 the Burgess clay served as both a water-generation agent and a reinforcing agent as indicated by the higher tensile strength of the non-clay containing compounds.

TABLE 7

| | Sample 29 | Sample 30 | Sample 31 | Sample 32 | Sample 33 | Sample 34 |
|---|---|---|---|---|---|---|
| Composition | | | | | | |
| Escorene ™ PP 1105 | 30 | 30 | 30 | 30 | 30 | 30 |
| (parts per 100 parts of | | | | | | |
| Escorene ™ PP 1105, | | | | | | |
| EXACT ™ 8201, and | | | | | | |
| Vistalon combined) | | | | | | |
| Exact ™ 8201 | 23 | | 23 | | 23 | |
| (parts per 100 parts of | | | | | | |
| Escorene ™ PP 1105, | | | | | | |
| EXACT ™ 8201, and | | | | | | |
| Vistalon combined) | | | | | | |
| Vistalon ™ 3666 | 47 | 70 | | | | |
| (parts per 100 parts of | | | | | | |
| Escorene ™ PP 1105, | | | | | | |
| EXACT ™ 8201, and | | | | | | |
| Vistalon combined) | | | | | | |
| Vistalon ™ 7500 | | | 47 | 70 | | |
| (parts per 100 parts of | | | | | | |
| Escorene ™ PP 1105, | | | | | | |
| EXACT ™ 8201, and | | | | | | |
| Vistalon combined) | | | | | | |
| Vistalon ™ 9303H | | | | | 47 | 70 |
| (parts per 100 parts of | | | | | | |
| Escorene ™ PP 1105, | | | | | | |
| EXACT ™ 8201, and | | | | | | |
| Vistalon combined) | | | | | | |
| Silane Masterbatch | 3.4 | 3.4 | 3.4 | 3.4 | 3.4 | 3.4 |
| (parts per 100 parts of | | | | | | |
| Escorene ™ PP 1105, | | | | | | |
| EXACT ™ 8201, and | | | | | | |
| Vistalon combined) | | | | | | |
| Sunpar 150 HT | | | 10 | 10 | 10 | 10 |
| (parts per 100 parts of | | | | | | |
| Escorene ™ PP 1105, | | | | | | |
| EXACT ™ 8201, and | | | | | | |
| Vistalon combined) | | | | | | |
| Epsom Salt | 0.2 | 0.2 | 0.2 | 0.2 | 0.2 | 0.2 |
| (parts per 100 parts of | | | | | | |
| Escorene ™ PP 1105, | | | | | | |
| EXACT ™ 8201, and | | | | | | |
| Vistalon combined) | | | | | | |
| Burgess Clay 210 | | | 3.5 | | | |
| (parts per 100 parts of | | | | | | |
| Escorene ™ PP 1105, | | | | | | |
| EXACT ™ 8201, and | | | | | | |
| Vistalon combined) | | | | | | |
| Property | | | | | | |
| Hardness (Shore A | 79 | 78 | 78 | 71 | 78 | 74 |
| @15 sec.) | | | | | | |
| Ultimate Tensile (psi) | 857 | 579 | 1065 | 486 | 831 | 602 |
| Elongation at Break (%) | 316 | 321 | 745 | 206 | 622 | 410 |

### Example 7

Samples 35-38 illustrate TPVs having a propylene homopolymer matrix component, and a rubber component comprising a combination of a metallocene plastomer and a high crystallinity EPDM rubber. As shown in Table 8, the substitution of a high crystallinity EPDM such as Vistalon™ 1703P (78 wt % ethylene and 36.5 J/g heat of fusion) for EXACT™ 8201 in this embodiment improves the softness (flexural modulus and hardness) of the TPV. Based on the gel content results, it is apparent that vinylsaline can be simultaneously grafted to both EXACT™ 8201 and Vistalon™ 1703P and crosslinked by the same type and amount of water-generating agent (Epsom salt).

The compositions in Table 8 were produced by two pass compounding using a 30 mm ZSK twin screw extruder. All ingredients were first blended together and fed into the extruder to complete the silane grafting reaction. In a second pass extrusion, Epsom salt was compounded together with the materials produced from the first pass to complete the crosslinking reaction. Samples 36-38 show a decrease in stiffness (flexural modulus), as compared to comparative sample 35, as more Vistalon™ 1703 P is used to replace the stiffer Exact™ 8201.

TABLE 8

| | Sample 35 | Sample 36 | Sample 37 | Sample 38 |
|---|---|---|---|---|
| Composition | | | | |
| Escorene ™ PP 1105 | 30 | 30 | 30 | 30 |
| (parts per 100 parts of | | | | |
| Escorene ™ PP 1105, | | | | |
| EXACT ™ 8201, and | | | | |
| Vistalon combined) | | | | |
| Exact ™ 8201 | 70 | 50 | 40 | 40 |
| (parts per 100 parts of | | | | |
| Escorene ™ PP 1105, | | | | |
| EXACT ™ 8201, and | | | | |
| Vistalon combined) | | | | |
| Vistalon ™ 1703P | | 20 | 30 | 30 |
| (parts per 100 parts of | | | | |
| Escorene ™ PP 1105, | | | | |
| EXACT ™ 8201, and | | | | |
| Vistalon combined) | | | | |
| Silane Masterbatch #1 | 3 | 3 | 3 | 3 |
| (parts per 100 parts of | | | | |
| Escorene ™ PP 1105, | | | | |
| EXACT ™ 8201, and | | | | |
| Vistalon combined) | | | | |
| Sunpar 150 HT | 5 | 5 | 5 | 10 |
| (parts per 100 parts of | | | | |
| Escorene ™ PP 1105, | | | | |
| EXACT ™ 8201, and | | | | |
| Vistalon combined) | | | | |
| Epsom Salt | 0.2 | 0.2 | 0.2 | 0.2 |
| (parts per 100 parts of | | | | |
| Escorene ™ PP 1105, | | | | |
| EXACT ™ 8201, and | | | | |
| Vistalon combined) | | | | |
| Property | | | | |
| Melt Flow Rate @ | 2.9 | 4.2 | 8 | 10.3 |
| 10X wt (dg/min) | | | | |
| Hardness (Shore D) | 48.4 | 45.2 | 42.2 | 32 |
| Ultimate Tensile | 1980 | 1785 | 1527 | 1090 |
| Stress (psi) | | | | |
| Elongation at Break | 434 | 448 | 410 | 294 |
| (%) | | | | |
| Tensile Modulus (psi) | | | | |
| 15% | 330 | 367 | 268 | 149 |
| 100% | 1263 | 1125 | 1005 | 816 |
| 200% | 1528 | 1354 | 1220 | 975 |
| 300% | 1741 | 1542 | 1388 | 1042 |
| Flexural Modulus, 1% | 16855 | 14606 | 12584 | 9636 |
| secant (psi) | | | | |
| Tear Strength (lb/in) | | | | |
| @ Max Load | 359 | 363 | 319 | 302 |
| @ Break | 213 | 211 | 183 | 138 |
| Compression Set, | 42.4 | 44 | 45.1 | 46 |
| Room Temperature & | | | | |
| 22 hr (%) | | | | |
| Tension Set 100% | 71 | 78 | 69 | 57 |
| @Room Temperature | | | | |
| (%) | | | | |
| Xylene Insolubles (%) | 58.65 | 53.51 | 47.57 | 42.17 |

### Example 8

In Samples 39-41, 2.2 parts per hundred resin of vinylmethoxysilane (VTMOS) masterbatch on a porous polypropylene carrier were added to 27.6/64.6 blends of Escorene™ PP 7715E4/Exact™ 8201. In each of samples 39-41, a different metal oxide/carboxylic acid combination was used.

TABLE 9

| | Sample 39 | Sample 40 | Sample 41 |
|---|---|---|---|
| Composition | | | |
| Escorene ™ PP 7715E4 | 27.6 | 27.6 | 27.6 |
| (parts per 100 parts of | | | |
| Escorene ™ PP 7715E4 and | | | |
| EXACT ™ 8201 combined) | | | |
| EXACT ™ 8201 | 64.6 | 64.6 | 64.6 |
| (parts per 100 parts of | | | |
| Escorene ™ PP 7715E4 and | | | |
| EXACT ™ 8201 combined) | | | |
| Silane Masterbatch #1 | 2.2 | 2.2 | 2.2 |
| (parts per 100 parts of | | | |
| Escorene ™ PP 7715E4 and | | | |
| EXACT ™ 8201 combined) | | | |
| Sunpar 150HT | 5 | 5 | 5 |
| (parts per 100 parts of | | | |
| Escorene ™ PP 7715E4 and | | | |
| EXACT ™ 8201 combined) | | | |
| Zinc Oxide | 0.3 | 0.3 | 0.3 |
| (parts per 100 parts of | | | |
| Escorene ™ PP 7715E4 and | | | |
| EXACT ™ 8201 combined) | | | |
| Isononanoic Acid | 0.3 | | |
| (parts per 100 parts of | | | |
| Escorene ™ PP 7715E4 and | | | |
| EXACT ™ 8201 combined) | | | |
| Isooctanoic Acid | | 0.3 | |
| (parts per 100 parts of | | | |
| Escorene ™ PP 7715E4 and | | | |
| EXACT ™ 8201 combined) | | | |
| Stearic Acid | | | 0.3 |
| (parts per 100 parts of | | | |
| Escorene ™ PP 7715E4 and | | | |
| EXACT ™ 8201 combined) | | | |
| Property | | | |
| Melt Flow Rate @10X wt, | 10.5 | 9.7 | 8.9 |
| (dg/min) | | | |
| Hardness (Shore D) | | | |
| @ 15 sec Elapsed Time | 40 | 41 | 39 |
| Ultimate Tensile Stress (psi) | 1298 | 1074 | 1299 |
| Elongation @ Break (%) | 586 | 278 | 667 |
| Tensile Modulus (psi) | | | |
| 50% | 696 | 725 | 862 |
| 100% | 856 | 885 | 827 |
| 300% | 1117 | 1166 | 1059 |
| Tear Resistance (lb/in) | | | |
| @ Max Load | 347 | 337 | 352 |
| Xylene Insolubles (%) | 43.1 | 40.9 | 39.4 |

### Example 9

In Sample 42, 3 parts per hundred resin of VTMOS masterbatch on a porous polypropylene carrier was added to a 30/70 blend of Escorene™ PP 1105/Exact™ 8201. In Sample 43, 3 parts per hundred resin of VTMOS masterbatch on a porous polypropylene carrier was added to a 30/70 blend of Escorene™ 7715/Exact™ 8201. Escorene™ 7715 is an impact copolymer having a polypropylene matrix with an uncrosslinked ethylene-propylene dispersed therein.

TABLE 10

| | Sample 42 | Sample 43 |
|---|---|---|
| Composition | | |
| Escorene ™ 1105 | 30 | |
| (parts per 100 parts of | | |
| Escorene ™ 1105, Escorene ™ | | |
| PP 7715, and EXACT ™ 8201 | | |
| combined) | | |
| Escorene ™ 7715 | | 30 |
| (parts per 100 parts of | | |
| Escorene ™ 1105, Escorene ™ | | |
| PP 7715, and EXACT ™ 8201 | | |
| combined) | | |
| EXACT ™ 8201 | 70 | 70 |
| (parts per 100 parts of | | |
| Escorene ™ 1105, Escorene ™ | | |
| PP 7715, and EXACT ™ 8201 | | |
| combined) | | |
| Silane Masterbatch #1 | 3 | 3 |
| (parts per 100 parts of | | |
| Escorene ™ 1105, Escorene ™ | | |
| PP 7715, and EXACT ™ 8201 | | |
| combined) | | |
| Epsom Salt | 0.2 | 0.2 |
| (parts per 100 parts of | | |
| Escorene ™ 1105, Escorene ™ | | |
| PP 7715, and EXACT ™ 8201 | | |
| combined) | | |
| Burgess Clay 201 | 3.5 | 3.5 |
| (parts per 100 parts of | | |
| Escorene ™ 1105, Escorene ™ | | |
| PP 7715, and EXACT ™ 8201 | | |
| combined) | | |
| Property | | |
| Density (g/cm³) | 0.917 | 0.908 |
| Melt Flow Rate (dg/min) | 0.59 | 0.97 |
| Tensile Strength (psi) | | |
| 10% Modulus, MD/TD | 692/566 | 469/353 |
| 50% Modulus, MD/TD | 1183/1031 | 835/696 |
| 100% Modulus, MD/TD | 1287/1139 | 949/793 |
| 300% Modulus, MD/TD | 1546/1385 | 1172/1001 |
| Break, MD/TD | 3745/3289 | 2722/2163 |
| Elongation @ Break (%) | 1167/1170 | 1187/1121 |

### Example 10

TPV compositions were prepared with an impact modified polypropylene copolymer (Escorene™ PP 8191) as the matrix component, and a rubber component comprising a metallocene plastomer (Exact™ 4033) and a halogenated rubber (Exxpro™ 89-1), as shown in Table 11.

TABLE 11

| | Sample | | Sample |
|---|---|---|---|
| | 44 | Sample 45 | 46 |
| Composition | | | |
| Escorene ™ PP 8191 | 40 | 40 | 40 |
| (parts per 100 parts of Escorene ™ | | | |
| PP8191, EXACT ™ 4033, and Exxpro ™ | | | |
| 89-1combined) | | | |
| Exact ™ 4033 | 55 | 55 | 47.5 |
| (parts per 100 parts of Escorene ™ | | | |
| PP8191, EXACT ™ 4033, and Exxpro ™ | | | |
| 89-1combined) | | | |
| Exxpro ™ 89-1 | 5 | 5 | 12.5 |
| (parts per 100 parts of Escorene ™ | | | |
| PP8191, EXACT ™ 4033, and Exxpro ™ | | | |
| 89-1combined) | | | |
| Zinc Oxide | | 0.05 | 0.2 |
| (parts per 100 parts of Escorene ™ | | | |
| PP8191, EXACT ™ 4033, and Exxpro ™ | | | |
| 89-1combined) | | | |
| Zinc Stearate | | 0.05 | 0.2 |
| (parts per 100 parts of Escorene ™ | | | |
| PP8191, EXACT ™ 4033, and Exxpro ™ | | | |
| 89-1combined) | | | |
| Property | | | |
| Melt Flow Rate @ wt, dg/min | 1 | 0.9 | 0.1 |
| Flexural Modulus, 1% secant, psi | 23900 | 22000 | 20500 |

In the presence of zinc oxide and zinc stearate, the plastomer can be grafted onto the halogenated rubber. But the combination of zinc oxide/zinc stearate is ineffective in crosslinking the plastomer, itself. The extra amount of zinc oxide and zinc stearate present can be used to crosslink the halogenated rubber. Sample 44 shows that by substituting 5 parts of the halogenated rubber for the plastomer, the resulting blend has a melt flow rate of 1 dg/min. Sample 45 is identical to Sample 44, except that 0.05 parts of zinc oxide per hundred parts of resin and 0.05 parts of zinc stearate per hundred parts resin were added. The resultant composition showed a slight decrease of melt flow rate due to crosslinking of the 5 parts of halogenated rubber. In Sample 46, 12.5 parts of the halogenated rubber was used to replace an equal amount of the plastomer, and the melt flow rate decreased to 0.1 dg/min, indicating an increased degree of crosslinking in the compound.

### Example 11

A 75 liter Banbury mixer was used to produce a TPV having a composition as described in Table 12 below. EXACTS 8201, Escorene™ PP 1105, Silane masterbatch, carbon black, and half of the Cel-Span were added to an empty barrel, and brought to a flux using both the high and medium rotor speeds in order to maintain a melt temperature of about 360° F. The ram was raised, the other half of the Cel-Span was added, and the mixture was once again brought to a flux. The ram was then raised and the Burgess Clay, Epsom salt, and AX-71 were added. The ingredients were mixed for an additional 30 seconds, after the maximum torque increase was observed. The total cycle time was about 4 minutes. The batch was next discharged into a downstairs hold mill at 335° F. A 4″ strip from the two-roll mill was next fed continuously into a short barrel extruder to form a 3″ thick continuous rope. The temperature of the rope was recorded to be 340° F. The extruded rope was fed to the top of an inverted L-shaped calendar to convert the molten rope into continuous thin gauge sheeting.

TABLE 12

| | (parts per 100 parts of |
|---|---|
| | Escorene ™ PP1105E1 |
| | and EXACT ™ 8201, |
| | combined) |
| Escorene ™ PP 1105E1 | 30 |
| (35 MFR polypropylene homopolymer) | |
| EXACT ™ 8201 (1 MI, 0.882 density, | 70 |
| ethylene-octene plastomer) | |
| Silane Masterbatch #1 | 3 |
| Cel-Span NH44 (non-halogen flame | 20 |
| retardant) | |
| Epsom Salt (hydrated salt for water | 0.1 |
| generation) | |
| Burgess Clay 210 (filler) | 3.5 |
| ADK AX-71 (processing aid) | 0.75 |
| Carbon Black | 2.0 |
| Total | 129.35 |

The temperature profile in Table 13 below was used to produce sheeting with a thickness of 3.8 mils, width of 58″, and at a production rate of 50 yards per minute.

TABLE 13

| | |
|---|---|
| Top Roll | 330-340° F. |
| Front Roll | 330-340° F. |
| Middle Roll | 330-340° F. |
| Bottom Roll | 300-310° F. |
| Pick Off #1 Roll | 290-300° F. |
| Pick Off #2 Roll | 300-310° F. |

The properties of the sheeting are given in Table 14 below.

TABLE 14

| | |
|---|---|
| Melt Flow Rate at 10X weight (dg/min) | 47.2 |
| Thickness (mil) | 3.8 |
| 50% Tensile Modulus - MD (psi) | 1650 |
| 100% Tensile Modulus - MD (psi) | 1790 |
| Tensile Stress @ Break - MD (psi) | 2470 |
| Elongation @ Break - MD (%) | 395 |
| Gel Content (%) | 32.1 |
| Oven Aging @ 276° F. & 1 week | 425% elongation |

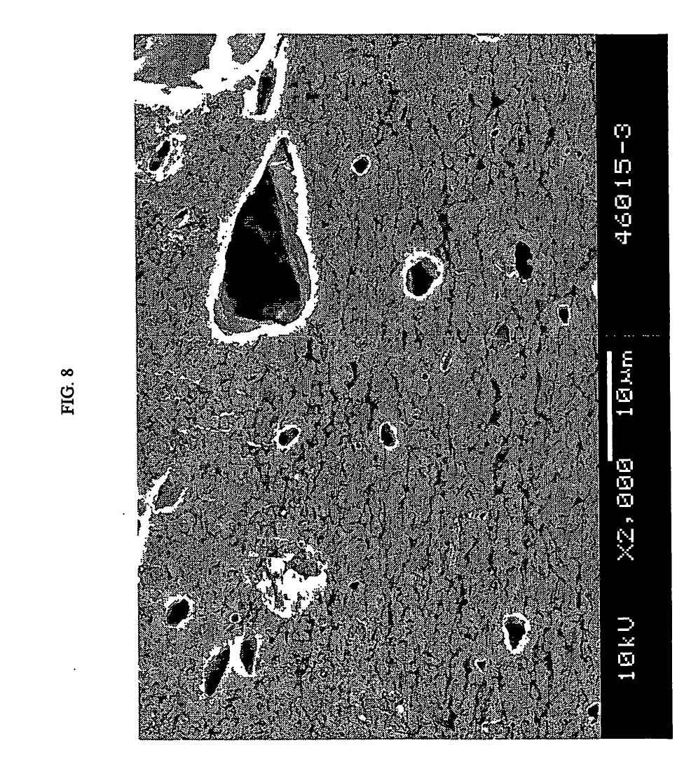

The low voltage SEM micrograph of the calendared sheeting is shown in FIG. 8. Referring now to FIG. 8, the white rugged particles are crosslinked plastomers, and the dark lines are the polypropylene matrix. The large and small embedded particles are carbon black or flame retardant.

### Example 12

A size D Banbury mixer was used to produce a TPV having a composition as described in Table 15 below. EXACT™ 8201, Escorene™ PP 1105, and Silane masterbatch were added to an empty barrel and brought to a flux using both the high and medium rotor speeds in order to maintain a melt temperature of about 360° F. The ram was raised and Burgess clay and Epsom salt were added. The ingredients were then mixed for an additional 30 seconds, after the maximum torque increase was observed. Sunpar 150M was injected into the mixer to cool the melt temperature of the batch. The total cycle time was about 4 minutes. The batch was next discharged into a melt fed pelletizing extruder to convert the batch into ⅛″ by ⅛″ pellets.

TABLE 15

| | (parts per 100 parts of |
|---|---|
| | Escorene ™ PP1105E1 and |
| | EXACT ™ 8201 combined) |
| Escorene ™ PP 1105E1 | 30 |
| (35 MFR polypropylene homopolymer) | |
| EXACT ™ 8201 (1 MI, 0.882 density, | 70 |
| ethylene-octene plastomer) | |
| Silane Masterbatch #1 | 3 |
| Epsom Salt (hydrated salt for water | 0.2 |
| generation) | |
| Burgess Clay 210 (filler) | 3.5 |
| Sunpar 150M (processing oil) | 12.0 |
| Total | 118.7 |

The pellets were then fed into the feed hopper of a Black-Clawson sheet extruder to produce 36″ width by 10 mils thick continuous sheeting under the conditions given in Table 16.

TABLE 16

| | |
|---|---|
| Extruder Zone 1 & Zone 2 | 350° F. |
| Extruder Zone 3 | 360° F. |
| Extruder Zone 4 to Zone 6 | 380° F. |
| Screen Pack Zone 1 & Zone 2 | 400° F. |
| Transfer Pipe Zone 1 through 3 | 400° F. |
| Melt Pump | 456° F. |

The properties of the sheeting are given in Table 17 below.

TABLE 17

| | |
|---|---|
| Melt Flow Rate at 10× weight (dg/min) | 0.6 |
| 10% Tensile Modulus - MD (psi) | 692 |
| 50% Tensile Modulus - MD (psi) | 1183 |
| 100% Tensile Modulus - MD (psi) | 1287 |
| 300% Tensile Modulus (psi) | 1546 |
| Ultimate Tensile Strength - MD (psi) | 3745 |
| Elongation @ Break- MD (%) | 1167 |
| Tear Strength @ Max Load - MD (lb/in) | 401 |

Various tradenames used herein are indicated by a ™ symbol, indicating that the names may be protected by certain trademark rights. Some such names may also be registered trademarks in various jurisdictions.

All patents, test procedures, and other documents cited herein, including priority documents, are fully incorporated by reference to the extent such disclosure is not inconsistent with this invention and for all jurisdictions in which such incorporation is permitted.

What is claimed is:

1. A process for making a thermoplastic vulcanizate (TPV) in a reactor, the process comprising:
a) forming a mixture in which a silane grafted resilient polymer component is dispersed in a thermoplastic matrix component by mixing in the reactor:
i) from 25 to 60 parts by weight of a resilient polymer component, per 100 parts by weight of the matrix component and resilient polymer component combined;
ii) from 40 to 75 parts by weight of the matrix component, per 100 parts by weight of the matrix component and the resilient polymer component combined; and
iii) a silane grafting agent, and
b) adding a solid water-generating agent to the reactor to crosslink the silane grafted resilient polymer component.

2. The process of claim 1 wherein step a) further comprises mixing a free radical generator in the reactor.

3. The process of claim 2 wherein the free radical generator is a peroxide.

4. The process of claim 1 wherein step a) further comprises mixing a hydrolysis catalyst in the reactor.

5. The process of claim 2 wherein step a) further comprises mixing a hydrolysis catalyst in the reactor.

6. The process of claim 5 wherein the silane grafting agent, free radical generator, and hydrolysis catalyst are added as individual components to the reactor.

7. The process of claim 5 wherein the silane grafting agent, free radical generator, and hydrolysis catalyst are added to the reactor as a mixture on a porous carrier polymer.

8. The process of claim 7 wherein the porous carrier polymer is selected from the group consisting of polyethylene and polypropylene.

9. The process of claim 1 wherein the silane grafting agent is a vinylalkoxysilane.

10. The process of claim 9 wherein the vinylalkoxysilane is selected from the group consisting of vinylmethoxysilane and vinylethoxysilane.

11. The process of claim 1 wherein the solid water-generating agent is selected from the group consisting of a metal oxide/carboxylic acid combination, Epsom salt, Glauber's salt, clay, water, talc, and combinations thereof.

12. The process of claim 1 wherein the matrix component comprises at least one of a polyolefin, a polyamide, and a polyester.

13. The process of claim 1 wherein the resilient polymer component comprises at least one of halobutyl rubber, ethylene-propylene rubber, ethylene-propylene-diene terpolymer rubber, natural rubber, synthetic rubber, amine functionalized synthetic rubber, and epoxy functionalized synthetic rubber.

14. The process of claim 1 wherein the resilient polymer component is an ethylene interpolymer.

15. The process of claim 1 wherein step a) includes mixing from 25 to 35 parts by weight of the resilient polymer component and from 65 to 75 parts by weight of the matrix component, per 100 parts by weight of the matrix component and resilient polymer component combined.

16. The process of claim 1 wherein step a) includes mixing 30 parts by weight of the resilient polymer component and 70 parts by weight of the matrix component, per 100 parts by weight of the matrix component and resilient polymer component combined.

17. The process of claim 1 wherein the reactor is a batch-type compounding apparatus.

18. The process of claim 1 wherein the reactor is a continuous-type compounding apparatus.

19. The process of claim 1 wherein the reactor is connected to a die suitable for extruding the product in the reactor into a shaped, fabricated product without an intervening pelletization step.

20. The process of claim 1 wherein the matrix component has a crystallinity as determined by DSC of at least 40% and the resilient polymer component has a crystallinity as determined by DSC of no more than 40%.

21. The process of claim 20 wherein the crystallinity of the matrix component and the resilient polymer component differ by at least 10%.

22. The process of claim 20 wherein the crystallinity of the matrix component and the resilient polymer component differ by at least 20%.

23. The process of claim 1 wherein the matrix component and the resilient polymer component are blended and simultaneously combined with the silane grafting agent.

24-32. (canceled)
